(19) United States
(12) Patent Application Publication
(10) Pub. No.: US 2015/0013541 A1
(43) Pub. Date: Jan. 15, 2015

(54) Electrostatic Precipitation Air Filter

(71) Applicant: LASKO HOLDINGS, INC., Wilmington, DE (US)

(72) Inventors: Rudy Vandenbelt, Ottawa (CA); Philippe Genereux, Ottawa (CA)

(73) Assignee: LASKO HOLDINGS, INC., Wilmington, DE (US)

(21) Appl. No.: 14/324,777

(22) Filed: Jul. 7, 2014

Related U.S. Application Data
(60) Provisional application No. 61/843,992, filed on Jul. 9, 2013.

(51) Int. Cl. B03C 3/47

(52) U.S. Cl. CPC B03C 3/47
USPC 96/98

(57) ABSTRACT

An improved collector electrode for an electrostatic precipitation air filter including a voltage source, an ion emitter, insulated drive electrodes, and attraction electrodes. The insulated drive electrodes include a multi-part structure having an electrically conductive material located between non-electrically conductive portions. The insulated drive electrodes allow an increased voltage potential between the attraction electrodes and the drive electrodes.

### CROSS REFERENCE TO RELATED APPLICATIONS

This application claims priority to U.S. Provisional Patent Application Ser. No. 61/843,992 filed Jul. 09, 2013 and entitled “Improved Electrostatic Precipitation Air Filter”, the contents of which are hereby incorporated by reference in their entirety herein.

### TECHNOLOGY FIELD

The present invention relates to air purifiers. More specifically, the present invention relates to electrostatic precipitator type air filters having an improved collector electrode.

### BACKGROUND

Electrostatic precipitation (ESP) air filters can effectively remove particulates from the air. ESP filters use a process of electrically charging particles in the air and collector plates in the device to attract and remove the charged particles from the air. Advantages of such filters may include permanent filters that can be cleaned, quiet operation, and lower power consumption when compared to devices and systems that use other types of filters.

Although conventional ESP filters have several advantages, they also have several disadvantages as well. There are three elements that regulate the function and effectiveness of an ESP filter. First is the velocity of air as it moves through the filter. Second is the volume of air moving through the filter over a unit of time, such as for example cubic feet per minute or cubic meters per hour. Third is the strength of the electrical charge used in the filter.

Air passing through a conventional ESP filter must flow at a sufficiently slow rate to accomplish two goals. The first goal is to permit sufficient time within the filter as the air passes through so the charged particles will be attracted and pulled from the air stream. The second goal is to reduce the effect of the air stream velocity on the particles that have already been pulled from the air stream. In effect, if the velocity of the air is too great the electrostatic charge may not be sufficient to cause the particles dissipated to remain within the filter.

Because the velocity of air must be maintained low, the size of a conventional ESP filter dictates the volume of air that the filter is able to clean over time. The larger the physical size of the filter, the greater the volume of air that can pass through. As can be surmised, large filters utilize more materials, require more space, and are more expensive to fabricate proportional to their size. Larger ESP filters often require larger or multiple air generators to overcome the increased air flow resistance and subsequent back pressure developed. This increases the overall power required to efficiently operate the air filtration system.

Increasing the strength or voltage potential of the electrostatic charge is limited in a conventional ESP filter. Electrical arcing begins to occur between the components of the filter as the voltage potential increases. In addition, as particles are removed from the air and build up on the components, the possibility of arcing increases. The internal arcing of the device creates intermittent noises such as crackling and snapping, which the end users do not want. Increasing the strength or voltage potential of the electrostatic charge may also increase safety risks if proper precautions are not implemented.

In short, although conventional ESP filters have advantages when compared to other type of air filters, the disadvantages of cost, noise, size, and cleaning capacity have not allowed such conventional ESP filter systems to be widely accepted in the consumer market.

### SUMMARY

In view of the deficiencies of conventional ESP filters, the following is a description of an improved ESP filter incorporating an innovative collector electrode assembly. The improved ESP filter overcomes many if not all of the disadvantages of conventional ESP filters and filter systems.

As described, the collector electrode assembly of the improved ESP filter includes drive and attraction electrodes in a combination that permits the electrostatic charge to have a greater voltage potential. This greater voltage potential within the electrostatic charge improves the performance and efficiency and lowers the cost of a device that may currently use a conventional ESP filters. The cost and performance advantages of the improved ESP filter will also allow ESP filtration to be used more readily in devices that currently use other forms of air filtration systems.

One advantage of the increased voltage potential is the ability of particles in the air to dissipate and adhere to the filter components is increased. This allows a higher air velocity to be used in a system using the improved ESP filter. The increased air velocity in turn increases the volume of air passing through the filter, which results in increased capacity.

Another advantage of the increased voltage potential is the ability to increase the space between the drive and attraction electrodes in the collector electrode assembly when compared to conventional ESP filters. Increased space between the drive and attraction electrodes has two advantages. The first advantage is that fewer electrodes are required within the collector electrode assembly, thereby decreasing the material and assembly costs. The second advantage provided by the increased space is the lowering of air flow resistance and subsequent back pressure developed as air moves through the improved ESP filter. This in turn decreases the power requirements of an air filtration system using the improved ESP filter.

The structure of the drive electrode used in the collector electrode assembly, according to embodiments of the present invention, mitigates if not eliminates the possibility of internal arcing. This in turn effectively stops intermittent noise from the improved ESP filter, which results in end users satisfaction. The structure of the drive electrode also decreases safety risks when compared to conventional ESP filters.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1 is a perspective view of an improved ESP filter, according to an embodiment of the present invention;

FIGS. 2A and 2B are perspective views of an embodiment of a drive electrode;

FIGS. 3A and 3B are perspective views of another embodiment of a drive electrode;

FIG. 4 is a perspective exploded view according to an embodiment of the present invention;

FIG. 5 is a perspective view showing the assembly of the embodiment of FIG. 4;

FIG. 6 is a schematic illustration of the performance characteristics of the assembly of the embodiment of FIG. 5;

FIG. 7 is another embodiment of the current invention; and

FIG. 8 is another embodiment of the current invention.

### DETAILED DESCRIPTION OF ILLUSTRATIVE EMBODIMENTS

The use of the improved ESP filter, according to embodiments of the present invention, is herein generally described in application to a portable air cleaner. This should not be construed, however, to limit the applicability of the improved ESP filter to only such devices. It is contemplated that other types of devices, such as commercial, industrial, and domestic devices, can benefit from the present invention. The advantages to air cleaners or other devices that may incorporate the improved ESP filter of the present invention include lower cost, less noise, smaller size, and greater cleaning capacity. These will provide a wide acceptance and application in consumer markets.

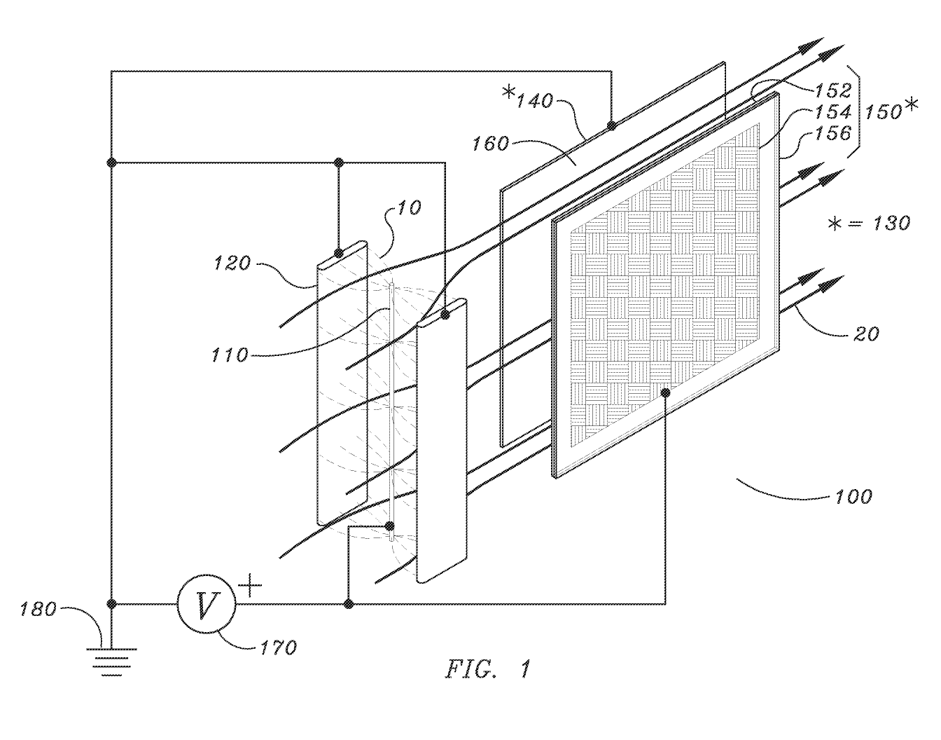

FIG. 1 is a perspective view of ESP air filter 100 according to embodiments of the present invention, having improved structure and performance characteristics. Air filter 100 includes ion emitter 110, collector electrode 130, and voltage source 170.

Ion emitter is a 110 is connected to voltage source 170 while ion strippers 120 located on opposite sides of ion emitter are connected to ground 180. As the voltage supplied by voltage source 170 to ion emitter 110 increases, the voltage potential between ion emitter 110 and ion strippers 120 cause ions to be pulled from ion emitter 110 and generate ion field 10. As shown, ion emitter 110 is an electrically conductive wire and ion strippers 120 are electrically conductive bars. The invention however is not so limited. It is contemplated that other types of ion emitters such as for example, carbon fiber brushes, corona discharge points, and the like could be used.

Collector electrode 130 includes attraction electrode 140 and drive electrode 150 located and spaced apart to define flow channel 160. Attraction electrode 140 may be fabricated of electrically conductive material such as steel, stainless steel, copper, aluminum, and the like. Alternately, attraction electrode 140 may be fabricated of a polymer infused with an electrically conductive material such as carbon. Attraction electrode 140 may also be fabricated of a non-electrically conductive material such as polymer, paper, minerals, and subsequently coated with a paint or ink which is infused with electrically conductive materials. Attraction electrode 140 may further be fabricated of a non-electrically conductive material and metalized by vacuum plating or with the addition of metalized conductive tape or film. In the present embodiment, attraction electrode 140 is connected to ground 180.

Drive electrode 150 includes first portion 152, electrically conductive substance 154, and second portion 156. As shown, first and second portions 152 and 156 are fabricated of an electrically non-conductive material such as polymer, paper, minerals, and the like. In an embodiment, electrically conductive substance 154 is formed of a liquid such as a paint or ink infused with electrically conductive material such as carbon. In an embodiment, conductive substance 154 includes a carbon content between 35% and 65%. Such liquids may be applied to first and/or second portions 152 and 156 through processes such as silk screening, spray applications, and the like. It is also contemplated that electrically conductive substance 154 could be a metalized conductive tape or film. Electrically conductive substance 154 is located between first and second portions 152 and 156 and is connected to voltage source 170.

Air flow 20 is generated by an air generator (not shown) and induced to flow through ion field 10 and subsequently through flow channel 160. Particles in air flow 20 are electrically charged as they pass through ion field 10. As shown, the particles are charged with a positive charge. When the particles pass through flow channel 160, drive electrode 150 is also charged with a positive charge; attraction electrode 140 is connected to ground which pushes the positively charged particles toward attraction electrode 140. The voltage potential between drive electrode 150 and attraction electrode 140 creates a filtration field. If the strength of the electrical charge in the particles is sufficient, the particle via electrostatic forces will adhere to attraction electrode 140, thereby being removed from airflow 20.

As shown, voltage source 170 generates a positive charge which is used to charge ion emitter 110 and drive electrode 150, while ion strippers 120 and attraction electrode 140 are connected to ground 180. It is contemplated that ion emitter 110 and drive electrode 150 could be connected to ground 180, and ion strippers 120 and attraction electrode 140 could be connected to the positive charge generated by voltage source 170. In one embodiment, the voltage potential generated by voltage source 170 is between 12 kilovolts and 18 kilovolts with reference to ground 180. In one embodiment, the voltage potential with reference to ground 180 generated by voltage source 170 is about 16 kilovolts.

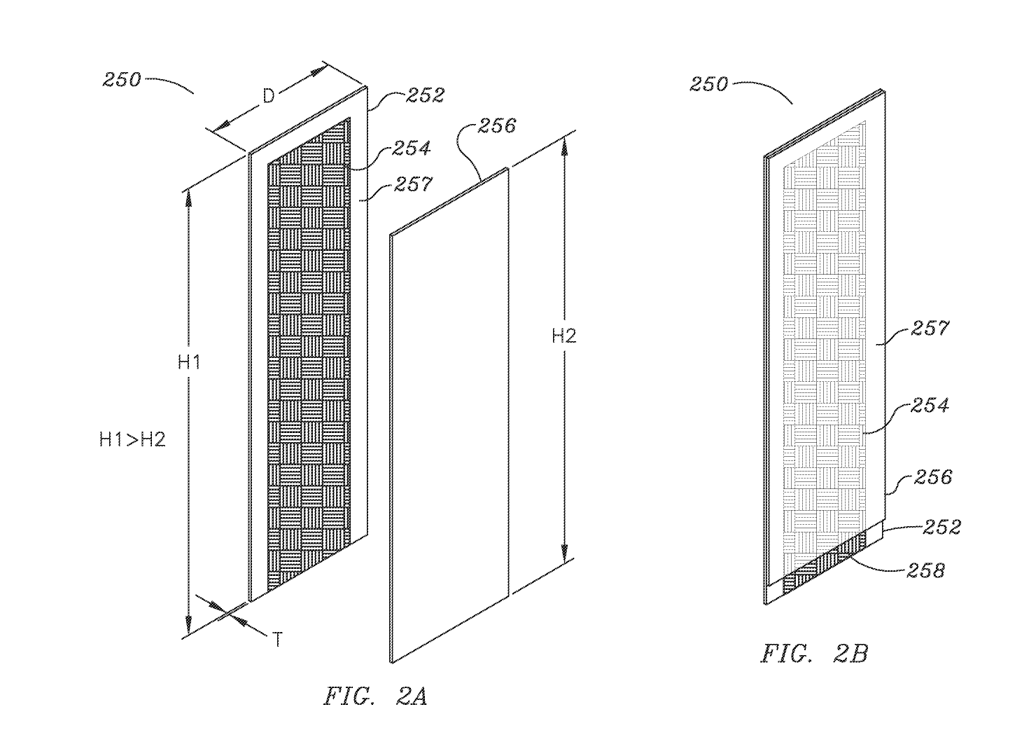

FIG. 2A is an exploded perspective view of an embodiment of a drive electrode 250, and FIG. 2B is a perspective view of drive electrode 250 assembled. Drive electrode 250 includes first portion 252, electrically conductive substance 254, and second portion 256. As shown, first portion 252 is defined by dimensions H1, D, and T. Second portion 256 is defined by similar dimensions wherein D and T are the same as first portion 252 and H2 is less than H1. It has been found that the optimum range of dimension T is within between 0.50 mm [0.020 inches] and 1.60 mm [0.063 inches]. In one embodiment, dimension T is about 0.81 mm [0.032 inches].

As shown, electrically conductive substance 254 is applied to first portion 252, creating uncoated surfaces 257 which extend around three sides of first portion 252. It is contemplated that first portion 252 may be etched and/or textured in the area to be coated by conductive substance 254. Etching and/or texturing will allow first portion 252 to accumulate more of conductive substance 254 on the surface. Electrically conductive substance 254 extends proximate one of the edges of first portion 252. Referring now to FIG. 2B, when assembled, first and second portions 252 and 256 comprise a unitary structure. The assembly of first and second portions 252 and 256 may utilize adhesives, ultrasonic welding, thermal welding, and/or other conventional assembly methods in conjunction with uncoated surfaces 257. Conductive substance 254 extends below second portion 256 to define exposed portion 258. Exposed portion 258 is used to make an electrical connection as required with conductive substance 254.

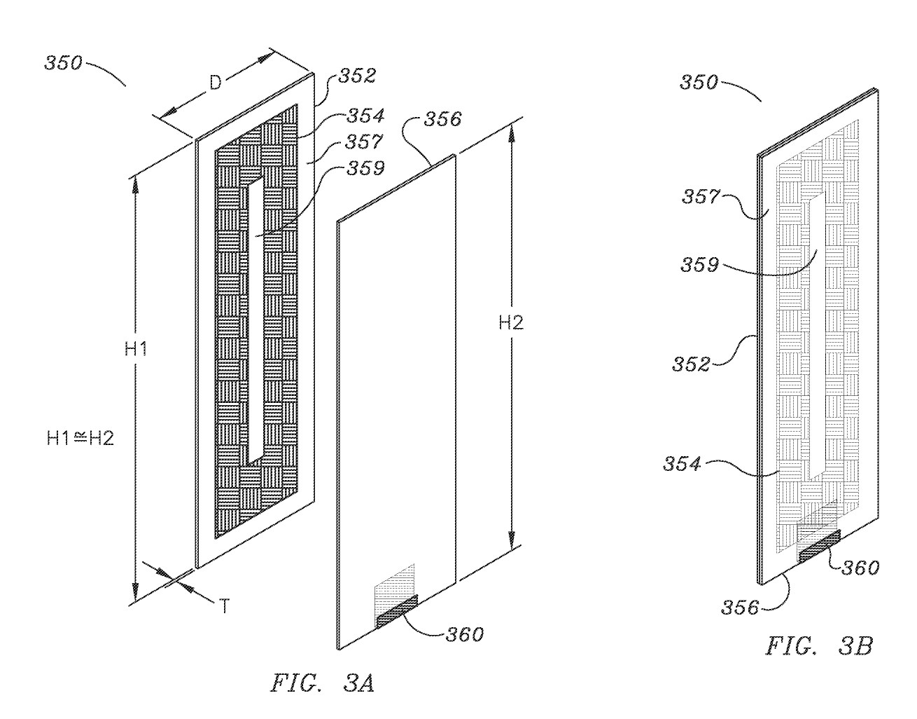

FIG. 3A is an exploded perspective view of an embodiment of a drive electrode 350, and FIG. 3B is a perspective view of drive electrode 350 assembled. Drive electrode 350 includes first portion 352, electrically conductive substance 354, second portion 356, and electrically conductive film 360. As shown, first portion 352 is defined by dimensions H1, D, and T. Second portion 356 is defined by similar dimensions wherein D and T are the same as first portion 352 and H2 is approximately equal to H1.

As shown, electrically conductive substance 354 is applied to first portion 352 creating uncoated surfaces 357 which extend around four sides of first portion 352 and defines masked area 359 located centrally to first portion 352. As shown, conductive film 360 is located on a surface of second portion 356 that faces conductive substance 354 and extends over an edge of second portion 356 and onto the opposing surface of second portion 356. Conductive film 360 may be, for example, a metalized tape having adhesive on at least one side.

Referring now to FIG. 3B, when assembled, first and second portions 352 and 356 comprise a unitary structure. The assembly of first and second portions 352 and 356 may utilize adhesives, ultrasonic welding, thermal welding, and/or other conventional assembly methods in conjunction with uncoated surfaces 357 and masked area 359. Masked area 359 allows additional assembly structure to be located in the center portion of drive electrode 350, thereby augmenting the structural integrity of drive electrode 350. When assembled, conductive film 360 contacts conductive substance 354 and is used to make an electrical connection with conductive substance 354.

As can be appreciated, the shape of drive electrodes 250 and 350 can be modified dimensionally to apply to many devices including portable air cleaners, HVAC systems for residential and commercial buildings, industrial uses, components for air conditioners, and the like. Also, the electrical connection of conductive substances 254 and 354 can be modified to conform to conventional electrical devices such as clips, soldering, and the like.

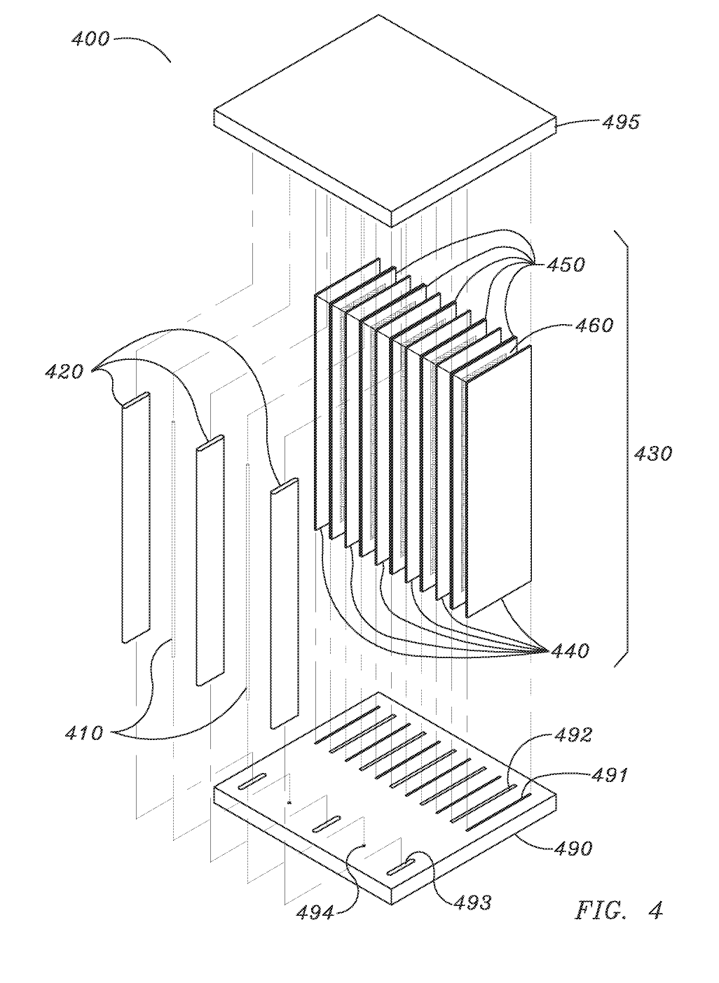

FIG. 4 is a perspective exploded view of air filter 400, according to embodiments of the present invention. Air filter 400 includes multiple ion emitters 410, collector electrode 430, multiple ion strippers 420, filter bottom 490, and filter top 495.

Collector electrode 430 may include multiple attraction electrodes 440 and multiple drive electrodes 450 alternately located and spaced apart to define multiple flow channels 460 therebetween. Filter bottom 490 may include multiple sockets A 491, multiple sockets B 492, multiple sockets C 493, and multiple sockets D 494, which correspond to multiple attraction electrodes 440, multiple drive electrodes 450, multiple ion strippers 420, and multiple ion emitters 410 respectively. Filter top 495 may include similar features to filter bottom 490.

It has been found that, in some embodiments, air filter 400 may not require the use of multiple ion strippers 420. As such, ions will be pulled from ion emitters 410 by the location and opposite voltage potential of attraction electrodes 440. The use of attraction electrodes 440 to pull ions from multiple ion emitters 410 has been shown to produce less ozone than systems including multiple ion strippers 420. Should ozone be produced by air filter 400, it is contemplated that an ozone absorption media (not shown) could be added within the structure of air filter 400 to remove unwanted ozone.

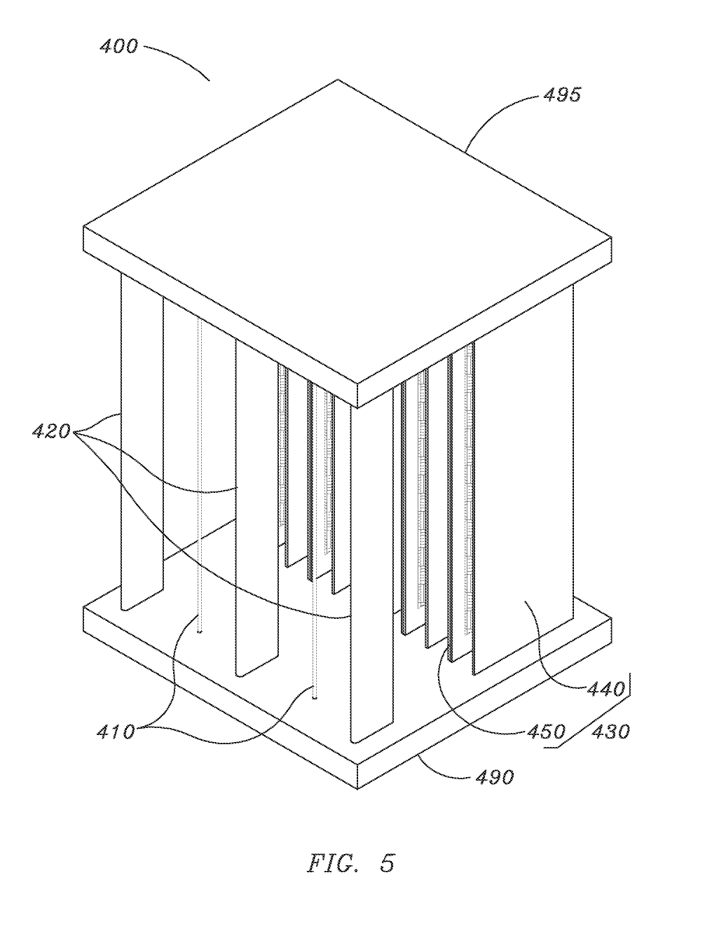

FIG. 5 is a perspective view showing the assembly of the embodiment of air filter 400 of FIG. 4. When assembled, the filter bottom 490 and filter top 495 locate the various components of air filter 400 as required to function as an ESP air filter. Electrical connection (not shown) of multiple attraction electrodes 440, multiple drive electrodes 450, multiple ion strippers 420, and multiple ion emitters 410 may be incorporated within filter bottom 490 and/or filter top 495. Multiple attraction electrodes 440 and multiple drive electrodes 450 may be assembled to filter bottom 490 and filter top 495 with conventional electric potting compound to seal and prevent intrusion of liquid.

The function of air filter 400 is similar to filter 100 of FIG. 1 except for the use of multiple attraction electrodes 440, multiple drive electrodes 450, multiple ion strippers 420, and multiple ion emitters 410. The use of multiple components as shown increases the number of air channels 460, thereby increasing the filtering capacity of air filter 400 when compared to air filter 100.

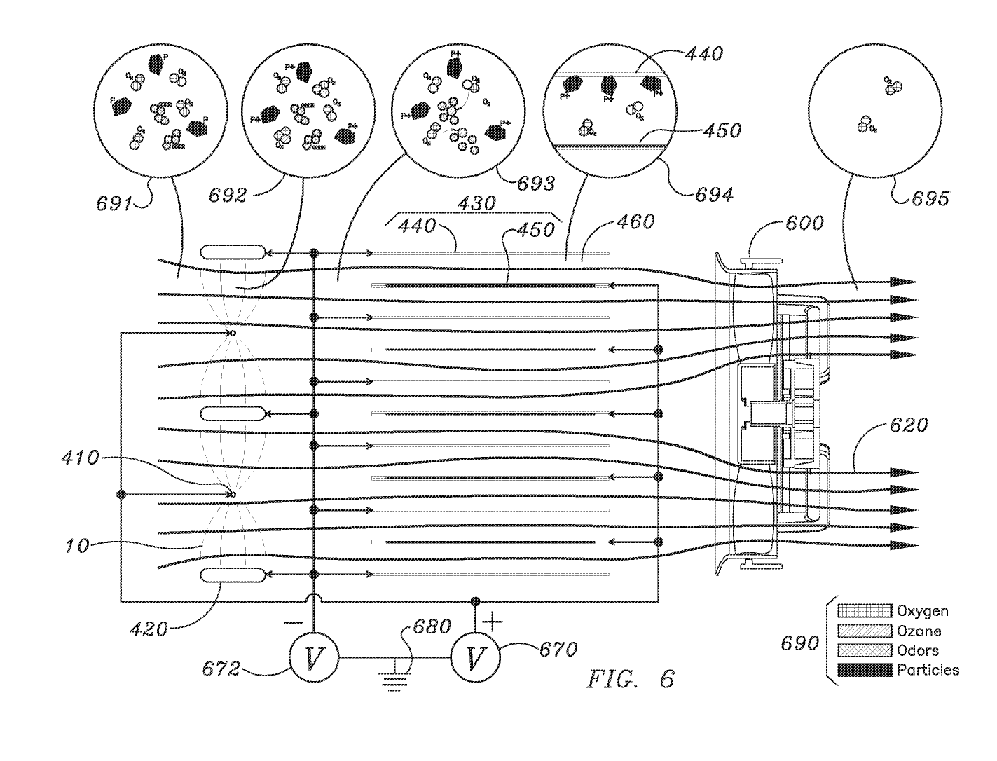

FIG. 6 is a schematic illustration of performance characteristics of air filter 400 assembly of FIG. 5. As shown, first voltage source 670 may supplies a positive voltage to ion emitters 410 and drive electrodes 450, while second voltage source 672 supplies a negative voltage to ion strippers 420 and attraction electrodes 440. It is contemplated that a single voltage source may be used to generate both a positive and negative voltage for air filter 400. It is also contemplated that certain of multiple attraction electrodes 440, multiple drive electrodes 450, multiple ion stripers 420, and multiple ion emitters 410 may be electrically connected to ground 680.

Air flow 620 is generated by air generator 600. As shown, air generator 600 uses an axial flow impeller; however the invention is not so limited. It is contemplated that centrifugal, transverse, and other conventional impeller types may be used without departing from the spirit of the invention.

Also shown are five stages of the air purification process: 691, 692, 693, 694, and 695. Key 690 is an aid to distinguish the various elements found in the five stages of air purification. Air flow 620 contains oxygen molecules, odors molecules, and other particles as shown in stage one 691 as air flow 620 is induced to pass through ion field 10. Air flow 620 passes through ionization field 10 in stage two 692, wherein the particles within the intake air flow 620 are charged with a positive charge. Some of the oxygen molecules may also be converted to ozone molecules (0₃) in stage two 692. Subsequently in stage three 693, the unstable ozone molecules degrade and destroy the odor molecules. As air flow 620 passes through air channels 460 in stage four 694, particles that were positively charged by ionization field 10 are repelled by drive electrode 450 and electrostatically adhere to attraction electrode 440. Stage five 695 illustrates clean air exiting air filter 400, where a substantial portion of the original particles and odor molecules contained in air flow 620 have been removed.

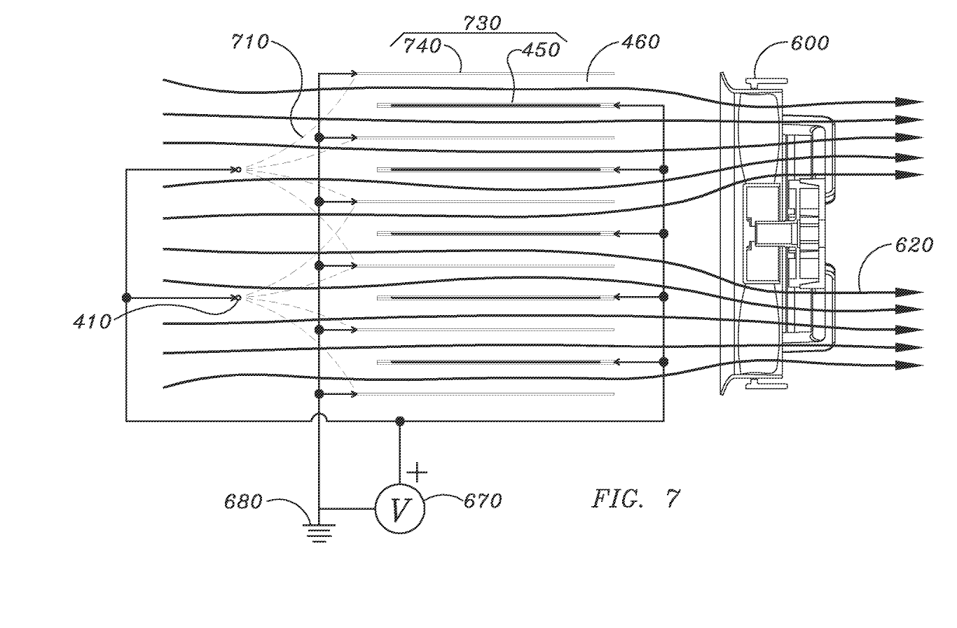

FIG. 7 is another embodiment of the current invention. Collector electrode 730 includes attraction electrodes 740 and drive electrodes 450. As shown, first voltage source 670 supplies a positive voltage to ion emitters 410 and drive electrodes 450, while attraction electrodes 740 are connected to ground 680. Ion field 710 is created by the voltage potential between ion emitters 410 and attraction electrodes 740. As shown, attraction electrodes 740 extend or are located closer to ion emitters 410, which facilitate the creation of ion field 710. In all other aspects the embodiment of FIG. 7 is similar to the embodiment of FIG. 6.

As shown in FIG. 6 and FIG. 7, the distance between attraction electrodes 440 and 740 respectively and drive electrode 450 is between 3.00 mm [0.120 inches] and 9.00 mm [0.350 inches]. In one embodiment, the optimum distance between attraction electrodes 440 and 740 respectively and drive electrode 450 is about 4.7mm [0.18 inches]. It is contemplated that additional structures, such as spacers, may be needed between attraction electrodes 440 and 740 and drive electrode 450. The requirement of spacers increases as the thickness “T” (see FIGS. 2A and 3B) decreases.

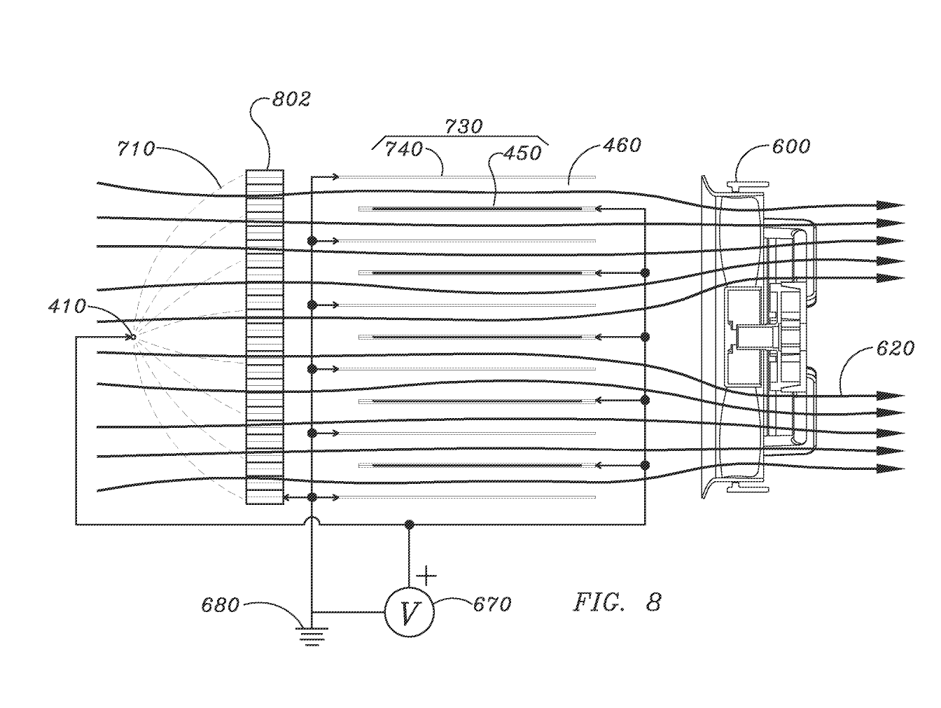

FIG. 8 is another embodiment of the current invention. As shown, the embodiment of FIG. 8 is similar to the embodiment of FIG. 7 except for the addition of intermediate filter 802 and single emitter 410. Intermediate filter 802 is located between collector electrode 730 and ion emitter 410. Intermediate filter 802 is comprised of air permeable material and may be composed of an electrical conductive material such as for example, steel, aluminum, copper or other metals or metal alloys.

First voltage source 670 supplies a positive voltage to ion emitter 410 and drive electrodes 450, while attraction electrodes 740 and intermediate filter 802 are connected to ground 680. Ion field 710 is created by the voltage potential between ion emitter 410 and intermediate filter 802. Additionally, intermediate filter 802 may be coated with carbon, manganese oxide, charcoal, titanium dioxide, and/or other materials for the purpose of facilitating odor and chemical removal from air flow 620 passing through air permeable intermediate filter 802. In all other respects, the embodiment of FIG. 8 is similar to the embodiments of FIGS. 6 and 7.

Although not explicitly shown and described, it is contemplated that conventional assembly techniques will be used to assemble air filters 100, 400, and other variations thereof. Such assembly techniques may include for example, screws, adhesives, heat staking, rivets, snaps, magnetic couplings, Velcro, and the like.

The unique structure of drive electrodes 150, 250, 350, and 450 as shown and described permits a greater voltage potential between drive electrodes 150, 250, 350, and 450 and corresponding attraction electrodes such as attraction electrodes 140, 440, and 740. The increased voltage potential improves performance and efficiency when compared to a conventional ESP air filter by increasing the strength of particle adherence to attraction electrodes 140, 440, and 740. This allows a higher air velocity to be used in a system, increasing the volume of air passing through air filter 100 and 400 which result in increased filtration capacity.

Another advantage of the increased voltage potential is the ability to increase space 160 and 460 between drive and attraction electrodes within collector electrodes 130 and 430 respectively. Increasing space 160 and 460 requires fewer electrodes, decreasing the material and lowering the air flow resistance and subsequent back pressure developed by air flow 20 and 620 moving through air filters 100 and 400. This in turn decreases the power requirements of an air filtration system using the improved ESP filter. Both of these advantages decrease the overall cost of air filters 100 and 400 when compared to conventional ESP air filters.

The insulated structure of the drive electrodes 150, 250, 350, and 450 mitigates the possibility of internal arcing within air filters 100 and 400. This in turn effectively stops intermittent noise of conventional ESP air filter which results in end users satisfaction. The insulated structure of the drive electrodes 150, 250, 350, and 450 also decreases safety risks when compared to conventional ESP air filters.

The use of electrically conductive substance 154, 254, and 354 in conjunction with the completed assembly of drive electrodes 150, 250, 350, and 450 as shown and described has significant cost advantages when compared to conventional ESP filters that utilize stainless steel and other like materials.

Although the invention has been described with reference to exemplary embodiments, it is not limited thereto. Rather teaching should be construed to include other variants and embodiments of the invention, which may be made by those skilled in the art without departing from the true spirit and scope of the present invention.

What is claimed:

1. An air filter comprising:
an ion emitter located in an airflow path for charging particulates entrained in said airflow path;
a collector electrode assembly located in said airflow path downstream from said ion emitter, said collector electrode comprising:
at least one electrically conductive attraction electrode comprising at least one collection surface;
at least one drive electrode comprising:
a first non-conductive portion located proximate a second non-conductive portion, each comprising a drive surface; and
an electrically conductive substance located between said first and said second non-conductive portions; and
a flow channel between said at least one attraction electrode and
said at least one drive electrode measured in a direction transverse to a direction of flow of said airflow path;
at least one voltage source electrically connected to said collector electrode assembly so as to create a voltage potential, wherein said voltage potential maintains a filtration field in said flow channel; and
wherein said filtration field acts to precipitate said charged particulates entrained in said airflow path onto said at least one collection surface of said at least one attraction electrode.

2. The air filter of claim 1, wherein said electrically conductive substance is applied to at least one of said drive surfaces of said first portion and said second portion as a liquid which subsequently at least one of dries and cures onto said drive surface.

3. The air filter of claim 2, wherein said liquid is at least one of a carbon infused paint and a carbon infused ink.

4. The air filter of claim 3, wherein at least one of said drive surfaces of said first portion and said second portion is etched and receives said liquid.

5. The air filter of claim 1, further comprising an electrical interface including a portion of said conductive substance not located between said first portion and said second portion of said drive electrode.

6. The air filter of claim 1, further comprising an electrical interface extending between said first and said second portions of said drive electrode and contacting said electrically conductive substance, wherein at least a portion of said electrical interface is not located between said first and said second portions of said drive electrode.

7. The air filter of claim 6, wherein said electrical interface is an electrically conductive film.

8. The air filter of claim 7, wherein said electrically conductive film includes an adhesive on at least one side of said electrically conductive film.

9. The air filter of claim 1, wherein said electrically conductive substance located between said first portion and said second portion of said drive electrode is an electrically conductive film.

10. The air filter of claim 9, wherein said electrically conductive film includes an adhesive on at least one side of said electrically conductive film.

11. The air filter of claim 1, wherein said first and second portions of said drive plate are assembled together as a unitary structure.

12. The air filter of claim 11, wherein said first and second portions of said drive plate are assembled together using at least one of thermal, chemical, and ultrasonic welding.

13. The air filter of claim 1, wherein said ion emitter and said conductive substance of said at least one drive electrode are energized to the same voltage potential with reference to ground.

14. The air filter of claim 1, wherein said ion emitter and said conductive substance of said at least one drive electrode are energized to different voltage potentials with reference to ground.

15. The air filter of claim 1, wherein said ion emitter further comprises at least one of a carbon brush, a corona discharge pin, and an electrically conductive wire.

16. A plate for use in an air filter comprising:
a first non-conductive portion;
a second non-conductive portion;
an electrically conductive substance applied to at least one surface of said first portion and said second portion; and
wherein in an assembled configuration, said first and second portions are assembled together so that a substantial portion of said electrically conductive substance is located between said first and second portions.

17. The plate of claim 16, wherein said electrically conductive substance is a liquid which subsequently at least one of dries and cures onto said at least one surface of said first portion and said second portion.

18. The plate of claim 17, wherein said liquid is at least one of a carbon infused paint and a carbon infused ink.

19. The plate of claim 16, further comprising an electrical interface extending between said first and said second portions and contacting said electrically conductive substance, wherein at least a portion of said electrical interface is not located between said first and said second portions.

20. The plate of claim 19, wherein said electrical interface is an electrically conductive film.

21. The plate of claim 16, wherein said assembled configuration comprises a unitary assembly using at least one of thermal, chemical, and ultrasonic welding.
